(19) United States
(12) Patent Application Publication
(10) Pub. No.: US 2012/0246830 A1
(43) Pub. Date: Oct. 4, 2012

(54) FOOTBOARD EGRESS DESIGN

(76) Inventor: David W. Hornbach, Brookville, IN (US)

(21) Appl. No.: 13/077,220

(22) Filed: Mar. 31, 2011

(51) Int. Cl. A61G 7/015; A61G 7/053

(52) U.S. Cl. 5/619; 5/81.1 R

(57) ABSTRACT

A person-support apparatus comprises a frame, a longitudinally extending member, and an endboard. The frame is configured to support a person thereon. The longitudinally extending member has a first end rotatably coupled to the frame at a first joint. The longitudinally extending member is configured to rotate between a first rotational orientation and a second rotational orientation with respect to the frame. The endboard is coupled to a second end of the longitudinally extending member and rotates with the longitudinally extending member between a first position and a second position. The endboard locates a first side of the frame in the first position and a second side of the frame in the second position.

### BACKGROUND OF THE DISCLOSURE

This disclosure relates generally to an endboard assembly attached to a person-support apparatus. More particularly, but not exclusively, one illustrative embodiment relates to an endboard assembly configured to be used as an ingress/egress assist for a person supported on a person-support apparatus.

People occasionally need assistance during ingress/egress to/from a person-support apparatus. While various ingress/egress assist devices have been developed, there is still room for improvement. Thus a need persists for further contributions in this area of technology.

### SUMMARY OF THE DISCLOSURE

One illustrative embodiment of the present disclosure includes an endboard assembly attached to a lower extremity support section of a person-support apparatus that can be rotated between a first rotational orientation and a second rotational orientation along the perimeter of the lower extremity support support section to assist a person attempting to at least one of ingress and egress to/from the person-support apparatus. In another illustrative embodiment, the endboard body can be rotated between a first rotational orientation and a second rotational orientation and translated along the perimeter of the lower extremity support support section between a first translational position and a second translational position to assist a person attempting to at least one of ingress and egress to/from the person-support apparatus.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective side view of a person-support apparatus in a substantially planar configuration with an endboard assembly according to one illustrative embodiment of the disclosure;

FIG. 2 is a perspective side view of the person-support apparatus of FIG. 1 in a chair configuration;

FIG. 3 is a perspective side view of the lower extremity support section of the person-support apparatus of FIG. 1 showing the endboard assembly;

FIG. 4 is a top view of the person-support apparatus of FIG. 1 showing the endboard assembly moving between a first rotational orientation and a second rotational orientation;

FIG. 5 is a perspective end view of the person-support apparatus of FIG. 1 in the chair configuration with the first and second endboard bodies moving from the first rotational orientation to the second rotational orientation;

FIG. 6 is a perspective end view of the person-support apparatus of FIG. 1 in the chair configuration with the first and second footboard bodies in the second rotational orientation;

FIG. 7 is a cross-sectional side view of the endboard assembly of FIG. 1 showing the first footboard body and the pivot joint, link arm, and latch mechanism of the pivot mechanism;

FIG. 8 is a top view of the person-support apparatus according to another illustrative embodiment showing the first and second footboard bodies rotating between first and second rotational orientations and translating between first and second translational positions; and

FIG. 9 is a partial sectional perspective side view of the endboard assembly of FIG. 8 showing the locking mechanism and the track and trolley of the movement mechanism;

FIG. 10 is a perspective end view of the person-support apparatus of FIG. 8 in the chair configuration with the first and second footboard bodies rotating from the first rotational orientation to the second rotational orientation; and

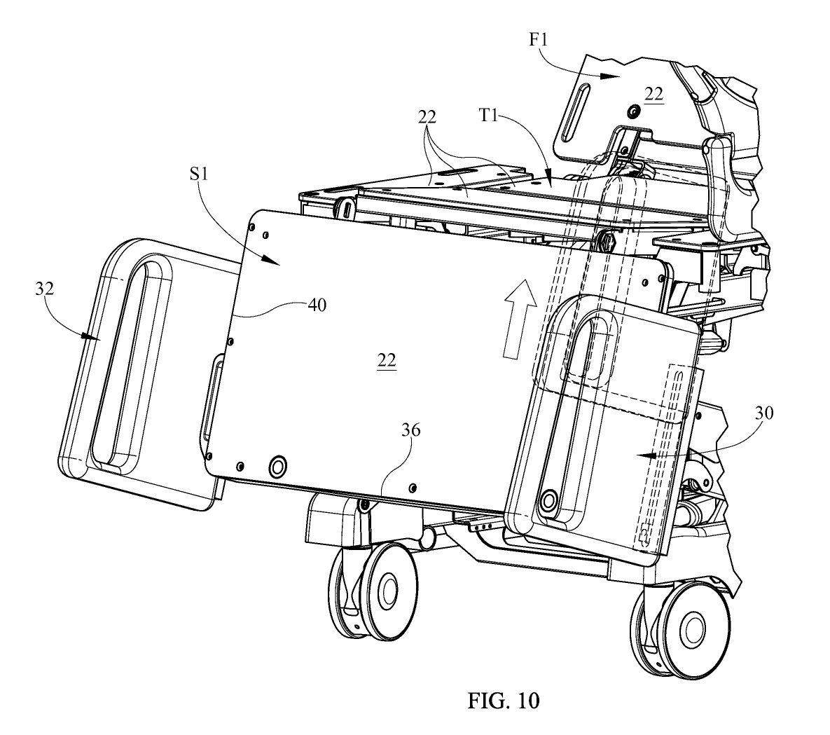

FIG. 11 is a perspective end view of the person-support apparatus of FIG. 8 in the chair configuration with the first and second footboard bodies translating from the first translational position to the second translational position.

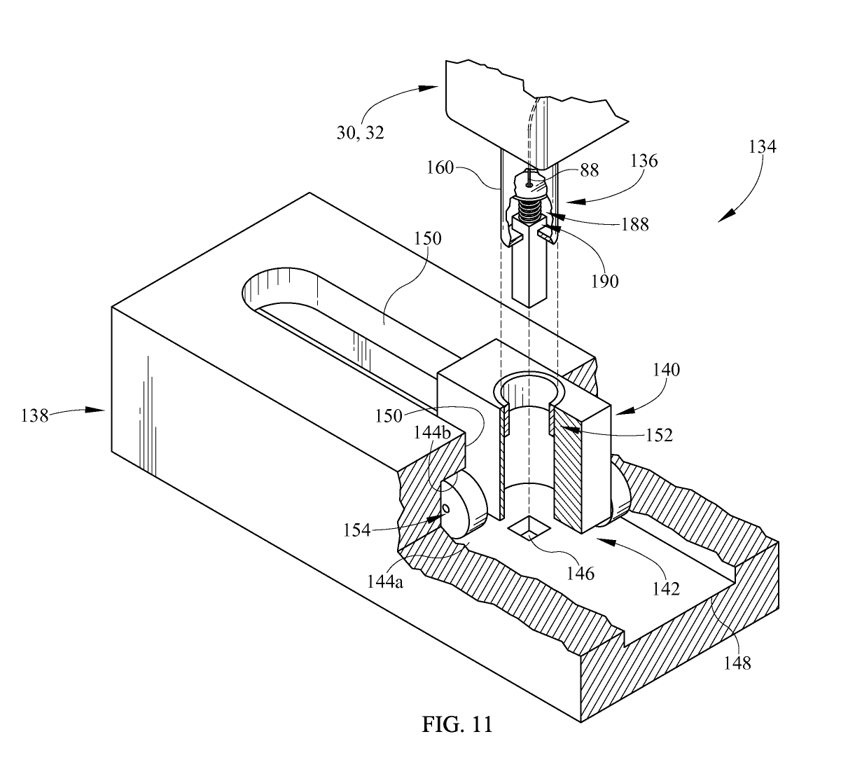

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure includes an endboard assembly attached to a lower extremity support section of a person-support apparatus that can be rotated between a first rotational orientation and a second rotational orientation along the perimeter of the lower extremity support support section to assist a person attempting to at least one of ingress and egress to/from the person-support apparatus. In another illustrative embodiment, the endboard body can be rotated between a first rotational orientation and a second rotational orientation and translated along the perimeter of the lower extremity support support section between a first translational position and a second translational position to assist a person attempting to at least one of ingress and egress to/from the person-support apparatus.

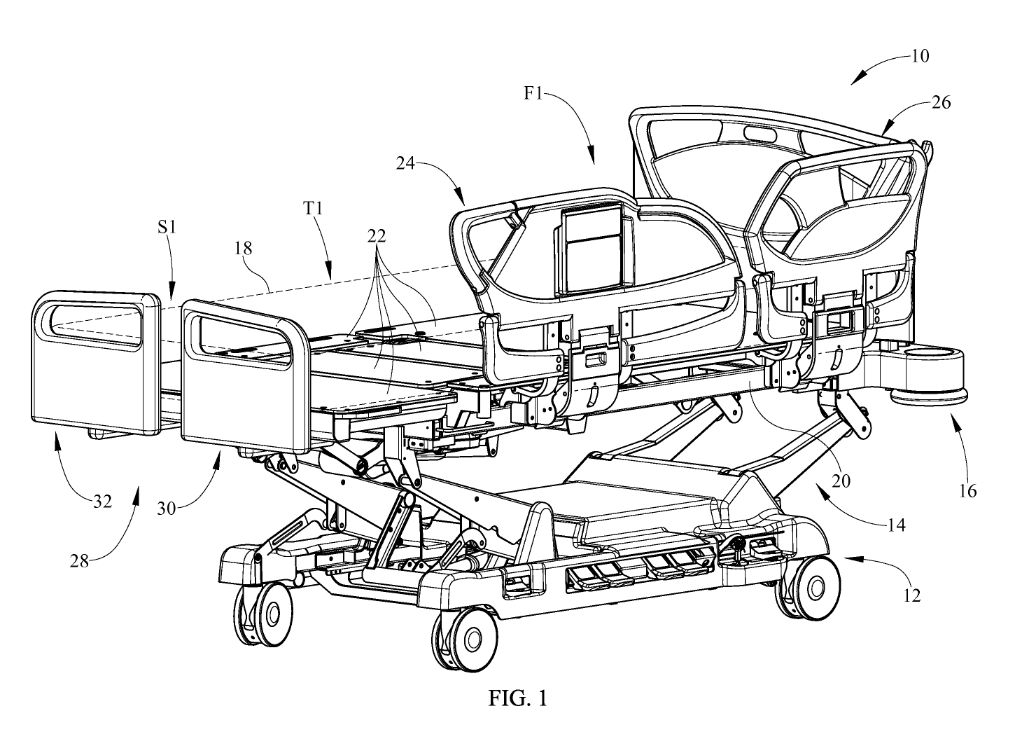

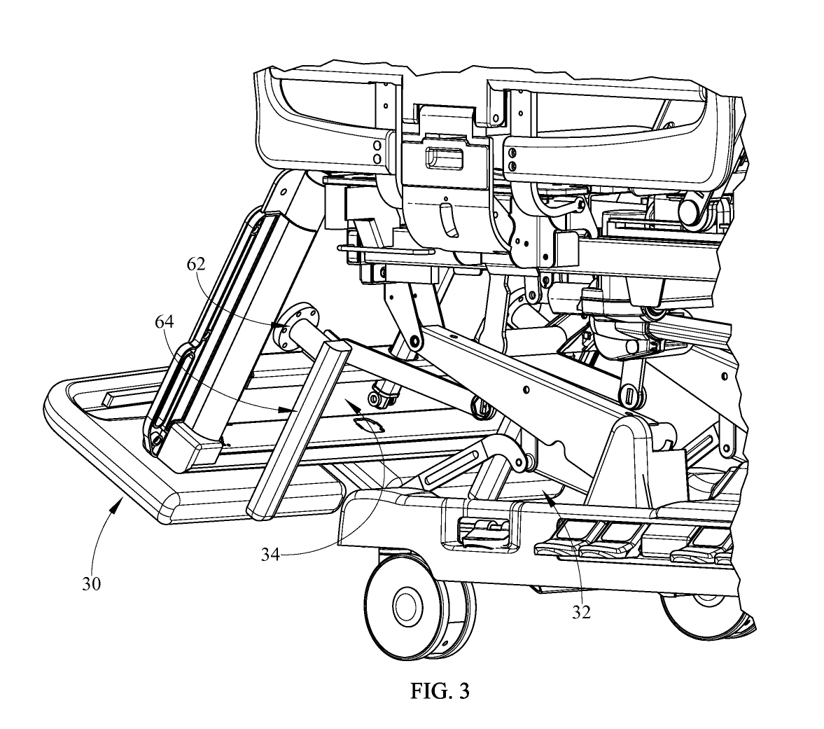

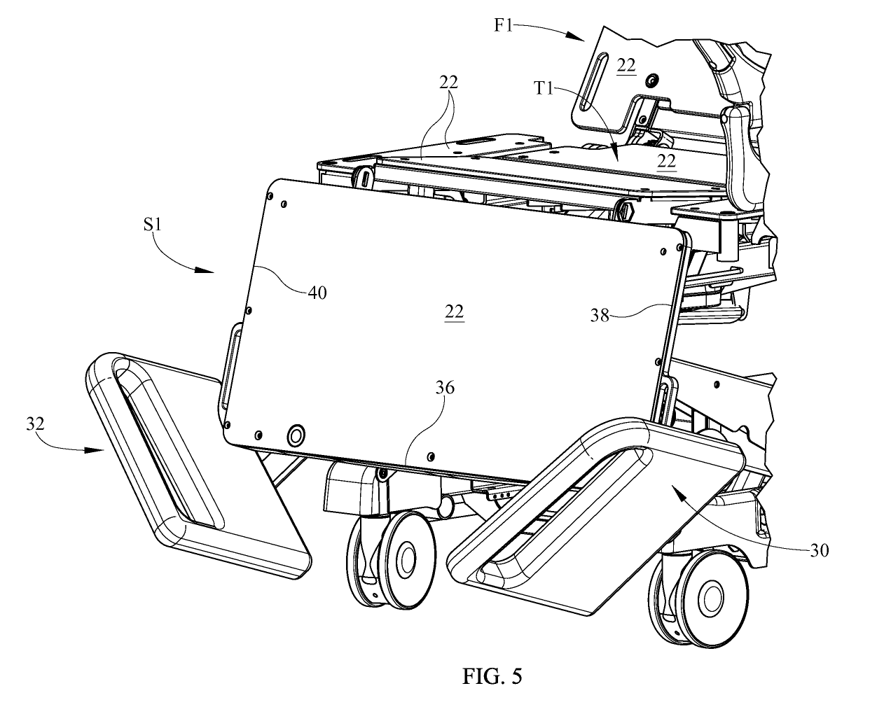

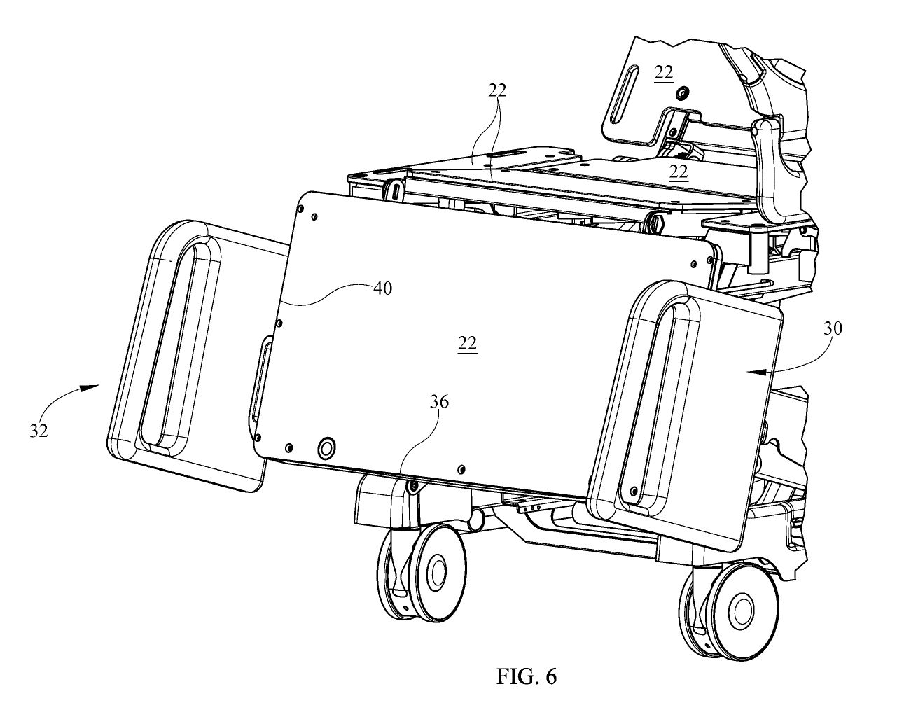

A person-support apparatus 10 according to one illustrative embodiment of the current disclosure is shown in FIGS. 1-7. The person-support apparatus 10 has a first section F1 or head support section F1, where the head and torso of a person can be positioned, a second section S1 or a lower extremity support support section S1, where the feet and legs of the person can be positioned, and a third section T1 or seat section T1 positioned between the first section F1 and the second section S1. In one example, the person-support apparatus 10 is a hospital bed. In other examples, the person-support apparatus 10 is a hospital stretcher, an operating table, a wheelchair, or other apparatus configured to support a person. The person-support apparatus 10 includes a lower frame 12 or base 12, a plurality of supports 14 coupled to the lower frame 12, and an upper frame 16 supported on the supports 14 above the lower frame 12. In one example, the supports 14 are lift mechanisms 14 that can move the upper frame 16 with respect to the lower frame 12. In another illustrative embodiment the person-support apparatus 10 can support a person-support surface 18 or mattress 18 thereon.

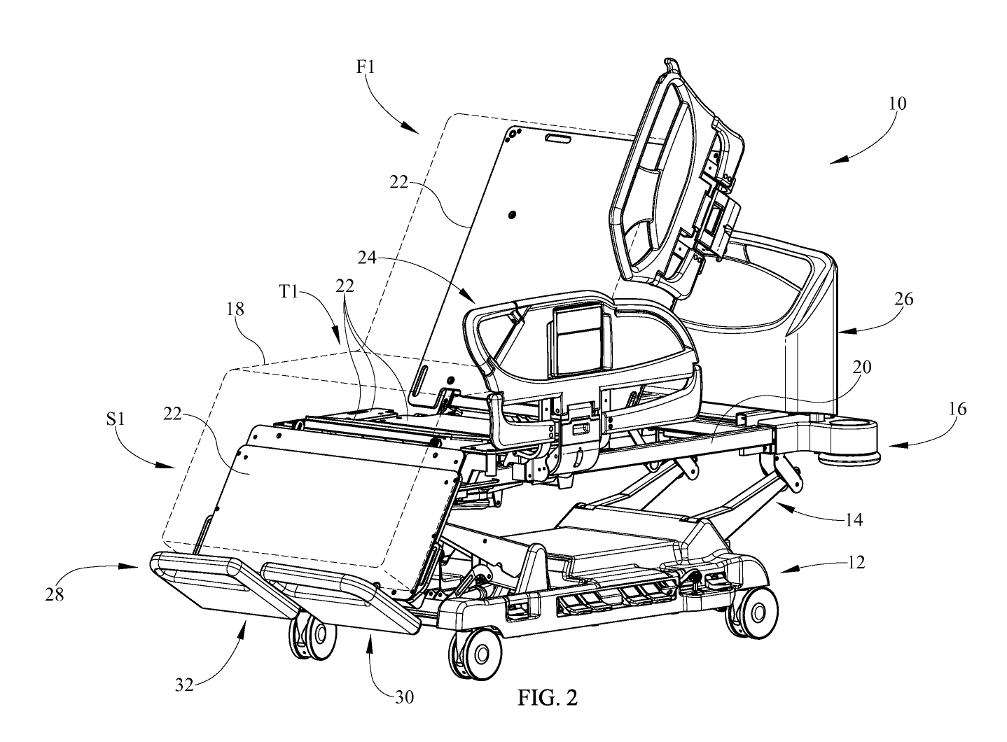

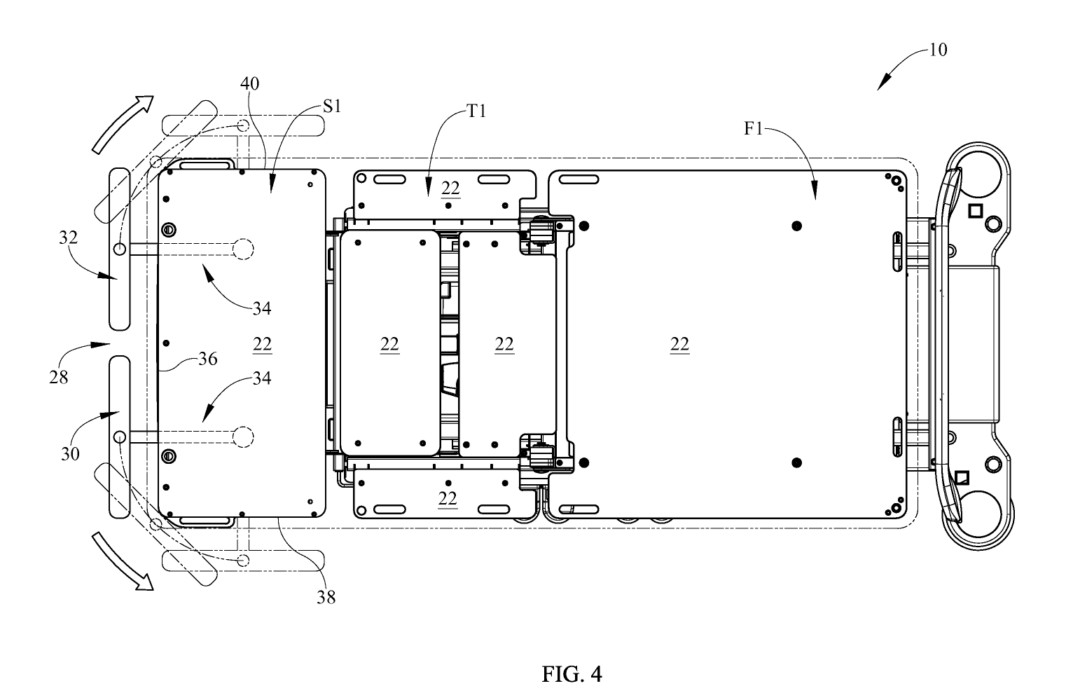

The upper frame 16 includes an upper frame base 20, a deck 22, siderails 24, and a headboard assembly 26 and a footboard assembly 28 as shown in FIGS. 1-7. The upper frame base 20 is coupled to the supports 14 and supports the deck 22 thereon. The deck 22 includes multiple sections that are movably coupled to the upper frame base 20 and/or one another and are configured to move with respect to the upper frame base 20 and/or one another. In one illustrative embodiment, the upper frame base 20, the supports 14, and the deck 22 are configured to cooperate with one another to move the person-support apparatus 10 between a substantially planar configuration as shown in FIGS. 1 and 4, and a chair configuration as shown in FIGS. 2-3 and 5-6.

The footboard assembly 28 is coupled to the lower extremity support section Si and is configured to define a portion of the perimeter edge of the upper frame 16 when the person-support apparatus 10 is in the substantially planar configuration, and to be used as an egress/ingress assist device when the person-support apparatus 10 is in the chair configuration as shown in FIGS. 1-7. The footboard assembly 28 includes a first footboard body 30 and a second footboard body 32 that are rotatably coupled to the lower extremity support section Si via pivot mechanisms 34. The first footboard body 30 and the second footboard body 32 are configured to rotate independent of one another between a first rotational orientation and a second rotational orientation shown in FIG. 4. In other embodiments, the first footboard body 30 and the second footboard body 32 can both engage a gear (not shown) or include portions with gear teeth (not shown) thereon that engage one another to synchronize rotation of the first footboard body 30 and the second footboard body 32 between the first rotational orientation and the second rotational orientation. In the first rotational orientation, the first footboard body 30 and the second footboard body 32 cooperate with one another to operate as a footboard and locate a first portion 36 of the perimeter edge of the upper frame 16. In the second rotational orientation, the first footboard body 30 and the second footboard body 32 are configured to function as ingress/egress assists for a person attempting to ingress/egress to/from the person-support apparatus 10 when it is in the chair configuration. Also in the second rotational orientation, the first footboard body 30 and second footboard body 32 locate a second portion 38 and a third portion 40, respectively, of the perimeter edge of the upper frame 16. The first footboard body 30 and the second footboard body 32 are generally parallel to one another and in the second rotational orientation, and generally co-linear in the first rotational orientation. In one example, the first footboard body 30 and the second footboard body 32 are minor images of one another. For the sake of brevity, only the structure of the first footboard body 30 will be described below.

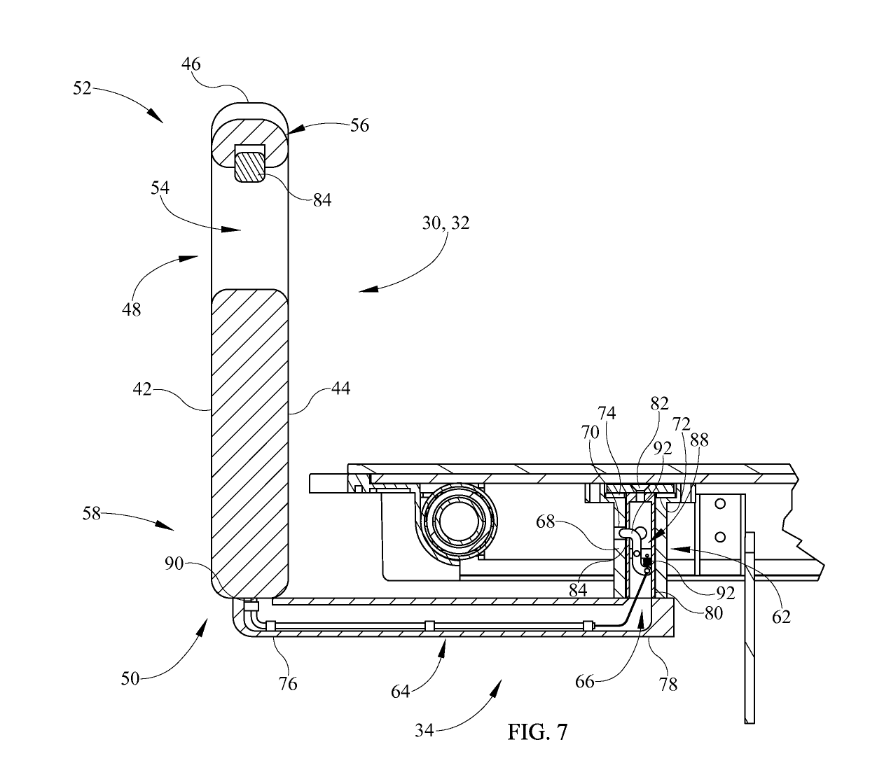

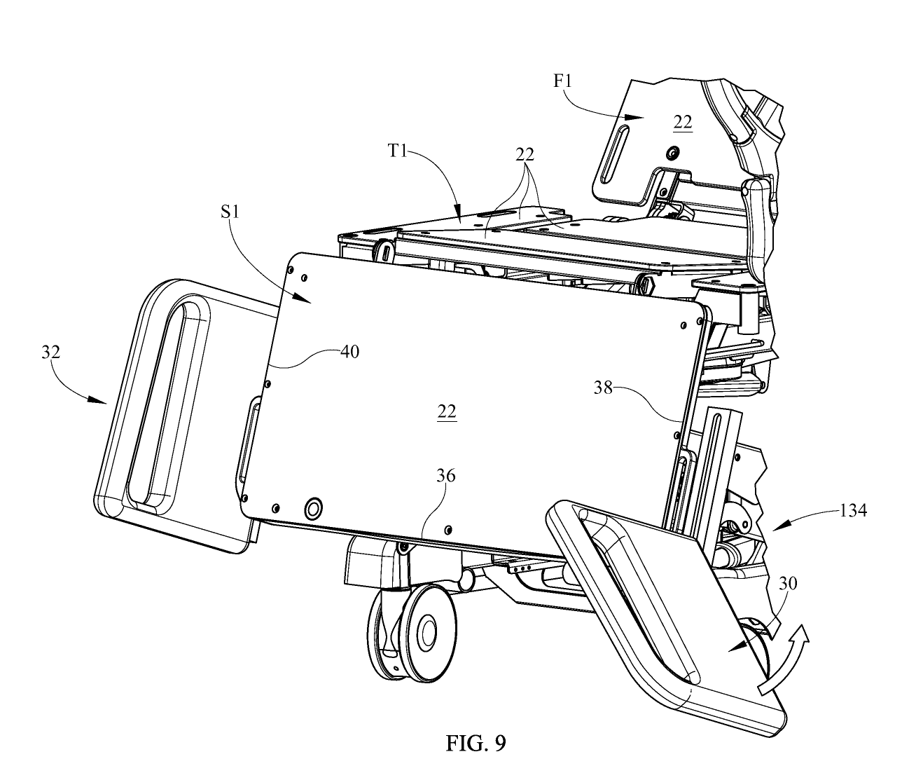

The first footboard body 30 includes a first surface 42, a second surface 44, and a third surface 46 or footboard perimeter edge 46 extending between the first surface 42 and the second surface 44, and has a grip portion 48 and a coupling portion 50 as shown in FIG. 7. The grip portion 48 is located along the top portion 52 of the first footboard body 30 and includes a grip opening 54 that passes through the first surface 42 and the second surface 44 and cooperates with the footboard perimeter edge 46 to define a grip 56. In the chair configuration, the grip 56 can be gripped by the person during ingress/egress into/out of the person-support apparatus 10. The coupling portion 50 is located along the bottom portion 58 of the first footboard body 30 and is secured to the pivot mechanism 34 with a fastener (not shown). The first footboard body 30 can alternatively include a shaft similar to shaft 160 described below and shown in FIG. 9, that extends from the first footboard body 30 and is received in a receptacle (not shown) in the pivot mechanism 34 to removably and pivotably couple the first footboard body 30 to the pivot mechanism 34. In one example, the shaft and receptacle are square in shape to prevent the first footboard body 30 from rotating with respect to the pivot mechanism 34.

The pivot mechanism 34 includes a pivot joint 60, a link arm 62 or longitudinally extending member 62, and a latch mechanism 64 as shown in FIG. 7. The pivot joint 60 is configured to facilitate rotation of the first footboard body 30 from the first rotational orientation to the second rotational orientation. The pivot joint 60 includes a cylindrical receptacle 66 configured to receive and retain a portion of the link arm 62. The cylindrical receptacle 66 includes locating holes 68 and a support surface 70. The support surface 70 is configured to facilitate rotation of the link arm 62 with respect to the cylindrical receptacle 66. In one illustrative embodiment, a bearing arrangement 72 is positioned between the support surface 70 and a disc 74 coupled to a portion of the link arm 62. In other embodiments, the support surface 70 can be at least partially composed of a bearing like material, such as, nylon, or can be lubricated with bearing lubricants, such as, grease.

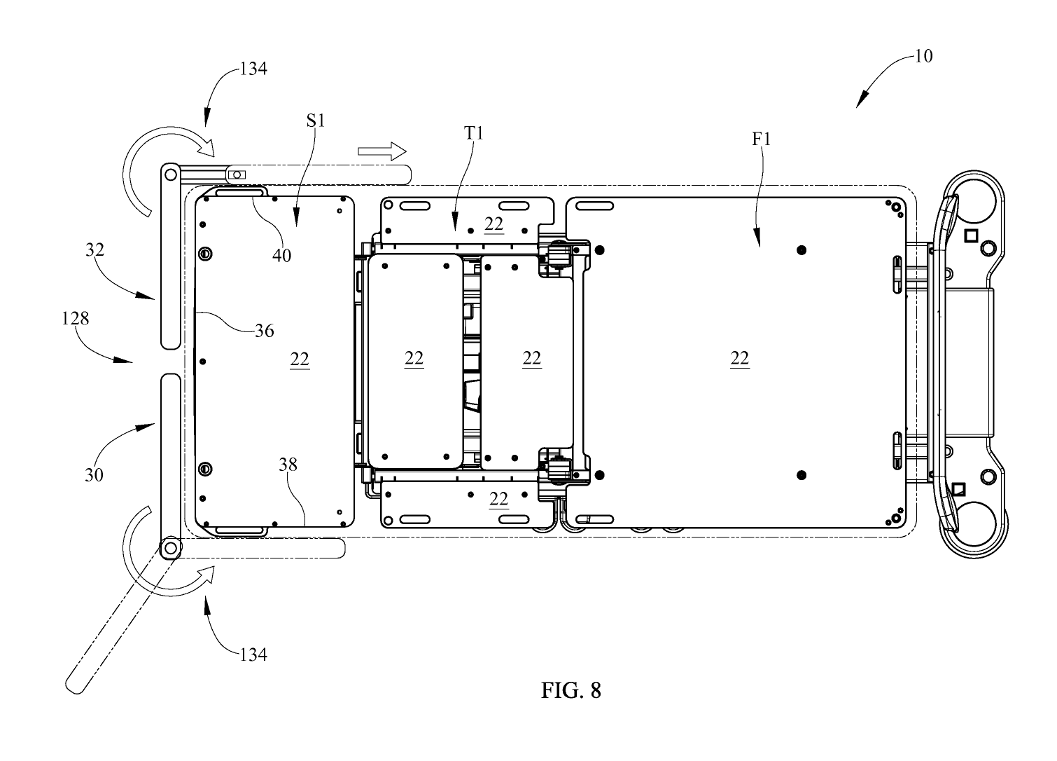

The link arm 62 includes a first end 76 and a second end 78 and movably couples the first footboard body 30 to the pivot joint 60. The first end 76 is coupled to the first footboard body 30 and the second end 78 is coupled to the pivot joint 60. In one illustrative embodiment, the link arm 62 is a fixed length. In another illustrative embodiment, the link arm 62 includes a telescoping portion (not shown) configured to at least one of increase and decrease the length of the link arm 62 as shown in FIG. 8. The second end 78 includes a cylindrical insert 80 that is configured to extend from the second end 78 and be rotatably retained within the cylindrical receptacle 66 by a retainer 82 and the disc 74. The cylindrical insert 80 includes a lock opening 84 that is generally concentrically aligned with one of the locating holes 68 when the first footboard body 30 and link arm 62 are maintained in the first rotational orientation and the second rotational orientation

The latch mechanism 64 is configured to selectively allow the first footboard body 30 to rotate with the link arm 62 between the first rotational orientation and the second rotational orientation. The latch mechanism 64 can also be configured to selectively allow the telescoping arrangement previously described above to increase/decrease in length. The latch mechanism 64 includes a handle 86, a lock 88, and a cable 90 coupled between the handle 86 and the lock 88. In one example, the handle 86 is recessed into the grip portion 48 and is configured to be depressed by a user to allow the first footboard body 30 to rotate with the link arm 62, and released to maintain the angular orientation of the first footboard body 30 and link arm 62 with respect to the lower extremity support section S1.

The lock 88 includes a spring loaded pin 92 that is configured to selectively engage one of a plurality of locating holes 68 in the cylindrical receptacle 66 of the pivot joint 60. In other embodiments, the lock 88 can be a friction lock or can be configured to selectively engage the upper frame 16. The spring loaded pin 92 is positioned in the cylindrical insert 80 and configured to extend through the lock opening 84 to engage one of the locating holes 68 to maintain the angular orientation of the first footboard body 30 and link arm 62 with respect to the lower extremity support section S1, and retract such that the spring loaded pin 92 does not engage the locating holes 68 when the first footboard body 30 and the link arm 62 are allowed to rotate about the pivot joint 60.

In operation, the first footboard body 30 and the second footboard body 32 are initially maintained in the first angular orientation along the first portion 36 of the perimeter edge of the upper frame 16. It should be appreciated that the person-support apparatus 10 can be in the substantially horizontal configuration, the chair configuration, or other configuration. The handles 86 are depressed by the user, which cause the spring loaded pins 92 to be retracted into the cylindrical insert 80 and disengage the locating holes 68. The user maintains the handles 86 in the depressed state while the first footboard body 30 and second footboard body 32 are moved with the link arms 62 between the first angular orientation and the second angular orientation. Once the first footboard body 30 and second footboard body 32 are in the second angular orientation, the user releases the handles 86, which causes the spring loaded pins 92 to extend through the lock opening 84 and engage the locating holes 68 to maintain first footboard body 30 and second footboard body 32 in the second angular orientation along the second portion 38 and third portion 40, respectively, of the perimeter edge of the upper frame 16. The person can then grip the grip portion 48 of the first footboard body 30 or second footboard body 32 to assist them when ingressing/egressing to/from the person-support apparatus.

In another illustrative embodiment, wherein like numerals indicate like features previously described, the footboard assembly 28 includes a first footboard body 30 and a second footboard body 32, a movement mechanism 134, and a latch mechanism 136. The first footboard body 30 and the second footboard body 32 are configured to selectively pivot between a first rotational orientation and a second rotational orientation with respect to the lower extremity support section S1 and translate along the lower extremity support section S1 between a first translational position and a second translational position as shown in FIG. 9. In one example, the first footboard body 30 and the second footboard body 32 pivot between the first rotational orientation and the second rotational orientation when the first footboard body 30 and the second footboard body 32 are in the first translational position. For the sake of brevity, the structure and function of the movement mechanism 134 and latch mechanism 136 associated with the first footboard body 30 will be described.

The first footboard body 30 is movably coupled to the lower extremity support section Si via the movement mechanism 134. The movement mechanism 134 includes a track 138 and a trolley 140 or transport 140 configured to move along the track 138 as shown in FIG. 9. The tracks 138 are coupled to the sides of the lower extremity support section S1 and extend there along. The tracks 138 include a guide slot 142, a track surface 144, and a plurality of locating holes 146. The guide slot 142 is recessed into the track 138 and includes a bottom surface 148 and side surfaces 150. The track surface 144 is recessed into the side surfaces 150 of the guide slot 142 and is configured to be engaged by the trolley 140. In one example, the track surface 144 includes an upper surface 144a and a lower track surface 144b. The locating holes 146 are located along the bottom surface 148 of the guide slot 142 and extend substantially vertically. In one illustrative embodiment, the locating holes 146 are square and extend through the bottom surface 148 of the guide slot 142. In other embodiments, the locating holes 146 can include a curved surface or a combination of curved and flat surfaces.

The trolley 140 is configured to move the first footboard body 30 along the track 138 between the first translational position and the second translational position. The trolley 140 includes a rotational mechanism 152 and a transport mechanism 154. In one illustrative embodiment, the rotational mechanism 152 includes a bearing arrangement 156 that engages the shaft 160 and allows the first footboard body 32 to rotate with respect to the trolley 140. The transport mechanism 154 is configured to engage the track surface 144 and move the trolley 140 longitudinally along the track surface 144 between the first translational position and the second translational position. In one illustrative embodiment, the transport mechanism 154 is a pair of wheels configured to ride between the recessed upper track surface 144a and lower track surface 144b. In other embodiments, the transport mechanism 154 can be a slide configured to slide along the track surface 144. In other embodiments, the trolley 140 can be coupled to a gear reduction assembly (not shown) that is configured to translate the first footboard body 30 as a function of the rotation of the first footboard body 30.

The latch mechanism 136 includes a handle 86, a lock, 188, and a cable 90. In one example, the handle 86 is recessed into the grip portion 48 and is configured to be depressed by a user to allow the first footboard body 30 to rotate and translate with respect to the lower extremity support section S1, and released to maintain the rotational and translational position of the first footboard body 30 with respect to the lower extremity support section S1. The lock 188 is configured to engage the locating holes 146 to maintain the position and rotational orientation of the first footboard body 30. In one illustrative embodiment, the lock 188 includes a spring loaded pin 190 positioned within the shaft 160 of the first footboard body 30 and configured to extend from the end of the shaft 160 to engage the locating holes 146 in the track 140. In one illustrative embodiment, the spring loaded pin 190 is square and extends from the first footboard body 30 in a substantially vertical orientation. In other illustrative embodiments, the pin 190 can include a curved surface or a combination of curved and flat surfaces. The flat surface of the spring loaded pin 190 is configured to cooperate with the flat surface of the locating hole 146 to prevent the first footboard body 30 from rotating.

In operation, the first footboard body 30 and the second footboard body 32 are initially maintained in the first rotational orientation and the first translational position. It should be appreciated that the person-support apparatus 10 can be in the substantially horizontal configuration, the chair configuration, or other configuration. The handles 86 are depressed by the user, which cause the spring loaded pins 190 to be retracted and disengage the locating hole 146. The user maintains the handles 86 in the depressed state while the first footboard body 30 and second footboard body 32 are rotated between the first rotational position and the second rotational position and translated along the side of the lower extremity support section S1 between the first translational position and the second translational position. Once the first footboard body 30 and second footboard body 32 are in the second rotational orientation and the second translational position, the user releases the handles 86, which causes the spring loaded pins 190 to engage the locating holes 146 and maintain first footboard body 30 and second footboard body 32 in the second rotational orientation and the second translational position.

Many other embodiments of the present disclosure are also envisioned. For example, a person-support apparatus comprises a frame and an endboard body. The frame configured to support a person thereon. The endboard movably coupled to the frame and configured to translate along a side of the frame between a first position and a second position.

In another example, a person-support apparatus comprises a frame and an endboard body. The frame is configured to support a person thereon. The frame includes a first support section and a second support section configured to pivot with respect to the first support section between a first angular orientation and a second angular orientation. The second support section is configured to support the lower extremities of a person supported on the frame. The endboard is rotatably coupled to the second support section and configured to move therewith as the second support section moves between the first angular orientation and the second angular orientation. The endboard is configured to rotate between a first rotational orientation and a second rotational orientation with respect to the second support section. A portion of the endboard is configured to assist a person attempting to at least one of ingress and egress to/from the frame when the endboard is in the second rotational orientation.

In still another example, a person-support apparatus comprises a frame, a longitudinally extending member, and an endboard. The frame is configured to support a person thereon. The longitudinally extending member has a first end rotatably coupled to the frame at a first joint. The longitudinally extending member is configured to rotate between a first rotational orientation and a second rotational orientation with respect to the frame. The endboard is coupled to a second end of the longitudinally extending member and rotates with the longitudinally extending member between a first position and a second position. The endboard locates a first side of the frame in the first position and a second side of the frame in the second position.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A person-support apparatus, comprising:
a frame configured to support a person thereon; and
an endboard movably coupled to the frame and configured to translate along a side of the frame between a first position and a second position.

2. The person-support apparatus of claim 1, wherein the endboard is also configured to pivot about a rotational axis with respect to the frame between a first rotational orientation and a second rotational orientation, the endboard being configured to locate the side in the second rotational orientation and locate a second side in the first rotational orientation.

3. The person-support apparatus of claim 1, wherein a portion of the endboard is configured to assist a person attempting to at least one of ingress and egress to/from the frame when the endboard is in the second position and the frame is in a chair configuration.

4. The person-support apparatus of claim 1, wherein a portion of the endboard is configured to assist a person attempting to at least one of ingress and egress to/from a side of the frame when the endboard is in the second position.

5. The person-support apparatus of claim 1, wherein the endboard is movably coupled to the frame by a movement mechanism including a transport and a track, the endboard being coupled to the transport and the transport being configured to move along the track to move the endboard between the first position and the second position.

6. The person-support apparatus of claim 1, wherein the frame includes a torso support section and a lower extremity support section movable with respect to one another, the torso support section and lower extremity support section being configured to move between a first orientation where the torso support section and lower extremity support section are substantially co-planar and a second orientation where the torso support section and the lower extremity support section cooperate to move the frame to a chair configuration, the endboard being movably coupled to the lower extremity support section and configured to translate along a side of the lower extremity support section.

7. A person-support apparatus, comprising:
a frame configured to support a person thereon, the frame including a first support section and a second support section configured to pivot with respect to the first support section between a first angular orientation and a second angular orientation, the second support section being configured to support the lower extremities of a person supported on the frame; and
an endboard rotatably coupled to the second support section and configured to move therewith as the second support section moves between the first angular orientation and the second angular orientation, the endboard being configured to rotate between a first rotational orientation and a second rotational orientation with respect to the second support section, a portion of the endboard being configured to assist a person attempting to at least one of ingress and egress to/from the frame when the endboard is in the second rotational orientation.

8. The person-support apparatus of claim 7, wherein the portion of the endboard is configured to assist a person attempting to at least one of ingress and egress to/from a side of the frame when the endboard is in the second rotational orientation.

9. The person-support apparatus of claim 7, wherein the portion of the endboard is configured to assist a person attempting to at least one of ingress and egress to/from the frame when the endboard is in the second rotational orientation and the frame is in a chair configuration.

10. The person-support apparatus of claim 7, wherein the endboard includes a first endboard body and a second endboard body that cooperate to locate a perimeter edge of a first side of the second support section in the first rotational orientation and locate a portion of a perimeter edge of a second side and a third side, respectively, of the second support section in the second rotational orientation.

11. The person-support apparatus of claim 7, wherein the endboard locates a perimeter edge of a first side of the second support section in the first rotational orientation and locates a perimeter edge of a second side of the second support section in the second rotational orientation, the endboard being configured to translate along the second side of the second support section between the first position and the second position.

12. The person-support apparatus of claim 7, wherein endboard is configured to be selectively maintained in at least one of the first rotational orientation and the second rotational orientation by a locking mechanism.

13. A person-support apparatus, comprising:
a frame configured to support a person thereon;
a longitudinally extending member having a first end rotatably coupled to the frame at a first joint, the longitudinally extending member being configured to rotate between a first rotational orientation and a second rotational orientation with respect to the frame; and
a endboard coupled to a second end of the longitudinally extending member and rotating with the longitudinally extending member between a first position and a second position, wherein the endboard locates a first side of the frame in the first position and a second side of the frame in the second position.

14. The person-support apparatus of claim 13, wherein the frame includes a first support section and a second support section configured to cooperate to move the frame between a substantially planar configuration and a chair configuration, the second support section being configured to support the lower extremities of a person, the first joint being coupled to the second support section, the endboard being configured to be gripped by a person to assist the person during at least one of ingress and egress to/from the person-support apparatus when the endboard is in the second position.

15. The person-support apparatus of claim 13, wherein the longitudinally extending member includes a length adjusting mechanism configured to at least one of increase and decrease the length of the longitudinally extending member.

16. The person-support apparatus of claim 13, wherein the endboard is pivotably coupled to the longitudinally extending member.

17. The person-support apparatus of claim 13, wherein the longitudinally extending member is configured to engage a first stop to define the first position and a second stop to define the second position.

18. The person-support apparatus of claim 13, wherein the endboard includes a latch mechanism configured to allow the endboard to be moved between the first position and the second position when the latch mechanism is in an unlatched position and maintain the endboard in at least one of the first position and the second position when the latch is in a latched position.

19. The person-support apparatus of claim 13, wherein the endboard includes a first endboard body and a second endboard body, the first endboard body being coupled to the longitudinally extending member and the second endboard body being coupled to a second longitudinally extending member that is rotatably coupled to the frame, the longitudinally extending member and the second longitudinally extending member engaging a gear mechanism configured to coordinate movement of the longitudinally extending member and the second longitudinally extending members.

20. The person-support apparatus of claim 13, wherein the portion of the endboard is configured to assist a person attempting to at least one of ingress and egress to/from a side of the frame.

21. The person-support apparatus of claim 13, wherein the portion of the endboard is configured to assist a person attempting to at least one of ingress and egress to/from the frame when the frame is in a chair egress position.
